(19) United States
(12) Patent Application Publication
(10) Pub. No.: US 2026/0291348 A1
(43) Pub. Date: Sep. 24, 2026

(54) ELECTRIC MACHINE HAVING A PRINTED CIRCUIT BOARD ARRANGED IN A STATOR HOUSING

(71) Applicant: Robert Bosch GmbH, Stuttgart (DE)

(72) Inventor: Bettina Straub, Buehl Eisental (DE)

(21) Appl. No.: 19/480,097

(22) PCT Filed: May 7, 2024
(86) PCT No.: PCT/EP2024/062529

§ 371 Date: Oct. 30, 2025

(30) Foreign Application Priority Data
May 11, 2023 (DE) 10 2023 204 376.9

(51) Int. Cl. H02K 13/10; H02K 11/00; H02K 11/30

(52) U.S. Cl. CPC H02K 13/10; H02K 11/0094; H02K 11/30

(57) ABSTRACT

Electric machine (10), in particular for adjusting movable parts in a motor vehicle, having a stator housing (22) which accommodates a stator (12) and a rotor (14), wherein the rotor (14) has a rotor shaft (16) on which a commutator (18) is arranged that is energizable by means of electrical brushes (20), and the stator housing (22) has an axial opening (24) with a circumferential edge (26) through which the rotor shaft (16) extends from the stator housing (22), wherein a printed circuit board (PCB) (30) is arranged transversely to the rotor shaft (16), and the printed circuit board (30) bears, at its peripheral region, (31) against the edge (26), and at least one microcontroller (84) is arranged on the printed circuit board (30) radially within the edge (26), in which position and rotational direction processing (85) of the rotor (14) is implemented.

### BACKGROUND

The present invention relates to an electric machine having a printed circuit board arranged in a stator housing.

DE 42 25 496 A1 discloses an electric drive unit in which an intermediate housing is arranged between a pole pot and a gearbox housing, into which a brush holder is integrated. The drive unit has a modular design, wherein a separately designed plug may be arranged at different positions on the drive unit. This means, for example, that different variants with or without an electronic housing may be achieved and, depending on the installation position of the drive unit, the plug connection may be adapted to the space available and the customer-specific mating connector. The electronics housing with the printed circuit board accommodated therein is, in each case, arranged radially outside the pole housing. The disadvantage of such a design is that the printed circuit board, with the various electronic components, emits electromagnetic interference (EMI), which may adversely affect other electronic functions in the motor vehicle. The task of the invention is to dispense with an electronic housing that is arranged radially outside the pole housing.

### SUMMARY

In contrast, the electric machine according to the invention has the advantage that, by arranging the microcontroller on the printed circuit board within the motor housing, an additional electronics housing may be dispensed with. The optimum utilization of the surface area of the printed circuit board radially within the circumferential wall of the stator housing means that no additional plug-in electronics and no electronics housing flanged to the motor housing need to be manufactured to implement various processing functions of the rotor position sensor. As a result, the position and the direction of movement of a part to be adjusted by means of the electric motor may be determined using the microprocessor arranged within the motor housing. This makes such an electric machine according to the invention suitable for communication with a central control unit in the motor vehicle, wherein all essential functions for the operation of the electric machine are implemented in the microcontroller, which is arranged radially inside the stator housing on the printed circuit board.

As the rotor position sensor is located on the printed circuit board directly opposite a signal transmitter on the rotor shaft, the paths for the sensor signals to the microprocessor are very short. Therefore, the sensor signals do not have to be routed over long distances from the plug-in electronics to the microprocessor, or via a plug connection to a printed circuit board in a separate electronic housing. As a result, the sensor signals are less susceptible to interference and may be processed more quickly in the immediately adjacent microcontroller.

This also eliminates the need to route the sensor signals from the printed circuit board to a connector plug on the electric machine. In contrast, a central control unit may communicate directly via motor signals with the microprocessor, which is arranged radially inside the stator housing.

For example, in the microcontroller, the rotor position signals may be processed directly to implement an anti-pinch function, which results in a particularly fast response time. The anti-pinch function prevents a passenger in the motor vehicle or other objects from being injured or damaged when a moving part is adjusted. The anti-pinch function may stop or reverse the electric motor in the event of an unusual increase in the adjustment force in order to release a trapped object.

By providing a current-limiting function in the microcontroller arranged radially within the stator housing, it is advantageously possible to dispense with arranging a thermal protection switch within the motor housing. For example, the current-limiting function may analyze and process different sensor signals within the motor housing in the microcontroller and generate a temperature model for the electric machine. If there is a risk of the electric motor overheating, the motor current may then be limited or switched off without the need for hardware components. This also makes it possible, for example, to implement a soft stop when the part to be adjusted reaches against a stop, and to prevent critical heating of the motor on block start-up.

Since the microcontroller is arranged in immediate spatial proximity to the electrical brushes, an H-bridge circuit may also be implemented in the microcontroller, which directly controls the motor current of the electrical brushes. As a result, the generation of disruptive EMI radiation may be reduced, such as that produced by motor current actuation in an externally arranged electronics unit. As the contact elements for the brushes are arranged on the same printed circuit board as the microprocessor, their connecting cables for the motor current may be kept very short, which has a very positive effect on the EMI compatibility of the electric motor.

The rotor position sensor on the printed circuit board may be designed particularly advantageously as a magnetic Hall sensor, which, in particular, may also be soldered directly onto the printed circuit board using SMD technology. In order to detect the direction of rotation of the rotor as well, a double Hall sensor is preferably used, which is preferably arranged on the circumference of the central through-hole in the printed circuit board. As a signal transmitter of the rotor shaft, a ring magnet that has different magnetic poles distributed over its circumference may advantageously be used. The Hall sensor is preferably arranged radially opposite the ring magnet. However, an axially opposite arrangement is also possible. The rotor shaft, with the ring magnet attached thereto, is inserted in the axial direction through the central through-hole in the printed circuit board such that the electrical brushes are in contact with the commutator, which is arranged axially adjacent to the ring magnet on the rotor shaft.

A shielding printed circuit board may be achieved particularly cost-effectively in that at least one continuously conductive conductor layer is arranged in the insulating substrate of the printed circuit board, on which no discontinuity is formed by the creation of circuits or the connection of electronic components. Such continuously conductive conductor layers may be manufactured as standard in PCB production, wherein two such planar conductive conductor layers are arranged as axially inner layers, and the circuits and electronic components are formed on two further outer conductor layers. The at least one planar conductive conductor layer is connected, by means of axial through-plated holes, to at least one axial side surface of the printed circuit board, which then bears axially against the flange in a conductive manner.

In order for the printed circuit board to reliably bear against the flange over its entire circumference, the circuit board has a radial overlap region with the flange. This overlap region is electrically conductive on the axial underside of the printed circuit board towards the flange. In order to also shield the central through-hole in the printed circuit board with regard to EMI, a conductive ground-contact region is formed on the upper side of the printed circuit board, around the central through-hole, toward the bearing plate. Preferably, this is formed over a substantial part of the circumference, and is electrically connected to the metal rotor bearing component. The electrical connection may be achieved by means of an additional conductive adapter element, or directly by forming an electrically conductive section on the bearing plate.

For energizing the electric motor, cartridge brushes or hammer brushes may be used. The brushes are arranged on a separately manufactured brush holder component, which is fastened to the underside of the printed circuit board and, in particular, is arranged entirely axially within the stator housing. For electrical contacting of the brushes, these are connected, for example, to the contact elements of the printed circuit board by means of flexible current conductors, in particular, by welding. The brush holder component is preferably formed from plastic, such that holders for the brushes may be integrally molded directly thereon. For assembly, the brush holder component may first be electrically and mechanically connected to the printed circuit board, and then inserted axially into the stator housing until the printed circuit board bears axially against the flange. Axially opposite the brush holder component, a bearing plate is fastened to the upper side of the printed circuit board, said plate having a bearing seat for the rotor bearing. The rotor bearing is designed as a cylindrical or spherical bearing, in particular, formed of metal. The bearing plate may likewise be made of plastic but has, around the bearing seat, an electrically conductive region that connects the rotor bearing to the ground contact region of the printed circuit board. For this purpose, the bearing plate may have a conductive coating or a separately manufactured, electrically conductive adapter element that is braced axially against the rotor bearing on the one hand, and against the ground-conduct region on the other. The brush holder is connected axially to the bearing plate, which is arranged axially on the opposite upper side of the printed circuit board. For this purpose, connecting elements, in particular, extend through the central through-hole, so that the at least one planar conductive conductor layer is not interrupted. For example, latching elements and/or clamping elements may be formed on the brush holder and/or the bearing plate, which interact with counter-latching elements and/or clamping elements of the bearing plate and/or the brush holder. As a result, the brush holder and the bearing plate, with the interposed printed circuit board, are formed as a preassembled sandwich component. This sandwich component is centered relative to the stator housing by means of the brush holder, and relative to the gearbox housing by means of the outer contour of the bearing seat of the bearing plate. The printed circuit board is positioned within the sandwich component by its central through-hole.

Advantageously, the stator housing has a flattened circular cross-section, such that it may also be installed in a limited installation space, for example, in the side door of the vehicle. The circumference thus has two parallel, mutually opposite planar sections and, between them, two circular sections. Advantageously, the circumference of the printed circuit board has the same contour, such that it extends approximately over the entire circumference radially beyond the dimensions of the axial opening of the stator housing in order to form the overlap region with the flange. As a result, a mechanically stable and reliable electrically conductive flange connection is created. If the central through-hole in the printed circuit board is rectangular or square, this may also be used to form a rotation lock between the brush holder plate, the bearing plate and the printed circuit board.

By arranging the separately manufactured connector plug radially outside the pole housing, the insertion direction and position of the corresponding customer-specific mating connector may be very easily adapted to the space available in the installation space without changing the basic design of the brush holder plate or the bearing plate or the printed circuit board. By designing a motor modular system with a consistently identical brush holder component, variation of the electronic functions, such as rotor position detection or electronic interference suppression, may be shifted exclusively to the printed circuit board, which is easier to modify. As a result of the constant stator-housing interface, a consistently reliable and good positioning of the brushes relative to the commutator may thus be ensured, and the electric motor may nevertheless be adapted to various customer requirements. Thus, even with different variants of the printed circuit board and/or of the connector plug, the interface between the stator housing, the printed circuit board, and the gearbox housing may always be designed identically, such that the flanges of the stator housing and of the gearbox housing are always reliably sealed.

By designing the printed circuit board with a radial extension that extends, over an angular region, radially beyond the flange to the separately manufactured connector plug, separately manufactured connecting elements between the printed circuit board and the connector plug may be dispensed with. Both the connection pins for the power supply and the pins for the motor signals may be soldered directly to the radial extension of the printed circuit board. In addition, the printed circuit board bears against the flange of the stator housing over a larger area in the circumferential region of the radial extension, and provides more space for arranging the microcontroller and/or further electronic components near the connector plug.

The printed circuit board may be manufactured particularly cost-effectively using surface-mounted device (SMD) technology, in which all the elements to be fitted are soldered on using SMD. For example, at least one suppression choke, or a varistor, or a capacitor, or a Hall sensor is soldered to the underside and/or the upper side by means of SMD technology. The contact elements for the carbon brushes are also advantageously designed as SMD parts. Owing to this SMD technology, the entire motor may also be used at higher temperatures, and the electronics, by virtue of the SMD assembly, are designed to be particularly resistant to vibration.

The printed circuit board may be very easily fastened axially between the flange of the stator housing and a mating flange of the gearbox housing by means of an axial assembly process. In this case, the gearbox housing may be made of plastic. For example, the two housing parts are connected to one another by means of screws, crimping, or another type of material deformation.

### BRIEF DESCRIPTION OF THE DRAWINGS

The invention is explained in more detail in the following description with reference to the exemplary embodiments shown in the drawings. It shows:

FIG. 1 a section of an electric machine according to a first exemplary embodiment, and

FIG. 2 a further exemplary embodiment of a printed circuit board of an electric machine from above,

FIG. 3 a further exemplary embodiment of a sandwich component from above, and

FIG. 4 a detailed illustration of an electric machine with an assembled sandwich component as shown in FIG. 3.

### DETAILED DESCRIPTION

FIG. 1 shows an electric machine 10 as used, for example, for adjusting movable parts, preferably window panes, sliding roofs, or seat components, in a motor vehicle. A stator 12 is arranged in a stator housing 22, within which a rotor 14 is disposed, the rotor shaft 16 of which extends axially from the stator housing 22 into an axially adjoining gearbox housing 60. Preferably, the stator 14 has permanent magnets 13, which interact with an electrical winding 15 of the rotor 14. The drive torque is transmitted from the rotor shaft 16 to a gearbox arranged in the gearbox housing 60. An output element 17, in particular a worm, is arranged on the rotor shaft 16, which interacts with other gearbox components. As a result, parts of a vehicle seat or a window pane in the motor vehicle, for example, are moved by means of a mechanism that is not shown. In axial direction 8, a brush holder plate 55 is arranged between the pole housing 22 and the gearbox housing 60, which accommodates electrical brushes 20 for electrically energizing a commutator 18 arranged on the rotor shaft 16. The brushes 20 may be designed as hammer brushes or, preferably, as cartridge brushes. The brush holder plate 55 is manufactured, for example, as a plastic component and is preferably arranged completely radially within the stator housing 22. Axially adjacent to the brush holder plate 55, a printed circuit board 30 (PCB) is arranged transversely to the rotor shaft 16. The printed circuit board 30 has a central through-hole 32 through which the rotor shaft 16 extends. At its radially outer periphery 31, the printed circuit board 30 bears in an electrically conductive manner against the stator housing 22. For example, a flange 28 is formed on an edge 26 of an axial opening 24 of the stator housing 22, against which the printed circuit board 30 bears in the axial direction 8. Preferably, the printed circuit board 30 has a substantially planar conductive conductor layer 36, which serves as a shielding plate for EMI radiation of the electric machine 10. Electronic components 44 are arranged on the printed circuit board 30. An electronic component 44 is designed as a microcontroller 84, which is arranged radially within the stator housing 22. As further components 44, contact elements 50 for supplying power to the electrical brushes 20 are arranged on the printed circuit board 30. Furthermore, the printed circuit board 30 is connected by means of conductor elements 65 to a connector plug 64 for supplying power to the electric machine 10, which is arranged radially outside the stator housing 22. Opposite the brush holder plate 55, on the other axial side of the printed circuit board 30, a bearing plate 56 is arranged, which has a bearing seat 57 for a bearing component 58 of the rotor shaft 16. The bearing component 58 is designed, for example, as a cylindrical or spherical bearing made of metal. The bearing component 58 is electrically conductively connected to the printed circuit board 30 via an adapter element 82, for example. Preferably, the bearing plate 56 is axially connected to the brush holder plate 55 by means of clips or clamping elements 98, such that the printed circuit board 30 is arranged between the brush holder plate 55 and the bearing plate 56 to form a sandwich component 70. The extension of the printed circuit board 30 in the radial direction 7 is preferably greater than the radial extension of the brush holder plate 55. For example, the gearbox housing 60 is connected to the stator housing 22 by means of connecting elements 66, so that the printed circuit board 30 is firmly fixed between the stator housing 22 and the gearbox housing 60.

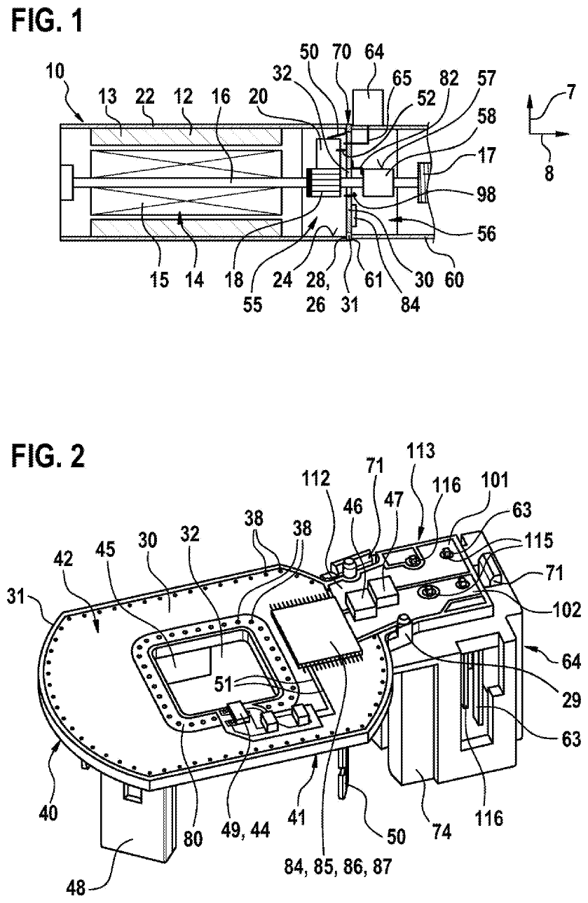

In FIG. 2, an upper side 42 of a further embodiment of a printed circuit board 30 is shown, which has a radial extension 113 that extends radially beyond the flange 28 of the stator housing 22. A conductive ground contact region 80 is formed on the upper side 42 around the central through-hole 32, which is interrupted at one point by a rotor position sensor 49, which is preferably configured as a Hall sensor 49. The microcontroller 84 is arranged on the upper side 42 in the angular region 112 of the connector plug 64, and is electrically connected to the rotor position sensor 49 via conductor tracks 51. In the microcontroller 84, position and rotational direction processing 85 of the rotor 14 and an anti-pinch function 86 are implemented, for which the rotor position signals of the rotor position sensor 49 are processed accordingly. Furthermore, a current-limiting function 87 for the electrical brushes 20 is implemented in the microcontroller 84, in which, based on signal processing in the microcontroller 84, the brush current is reduced by software when there is a risk of thermal overheating of the electric machine 10. At the angular region 112, at which the separately formed connector plug 64 is arranged, the radial extension 113 of the printed circuit board 30 extends beyond the connector collar 74 of the connector plug 64. Due to the fact that the microcontroller 84 is arranged directly adjacent to the rotor position sensor 49, and the rotor position signals are processed directly in the microcontroller 84, it is not necessary in this embodiment to route the rotor position signals to the connector plug 64. On the printed circuit board 30, further electronic components 44 are arranged, for example, for the circuit configuration of the microcontroller 84, or additional capacitors 47, or varistors 46, or interference suppression elements 45, 48. As further components 44, contact elements 50 for supplying power to the electrical brushes 20 are again soldered onto the printed circuit board 30. On an underside 41 of the printed circuit board 30, an electrically conductive overlap region 40 is formed, which in this case extends, in particular, substantially over the circumference of the flange 28, and bears axially against the flange 28 of the stator housing 22. At the radially outer edge 31 of the printed circuit board 30 and/or at the central through-hole 32, several through-plated holes 38 are formed, for example, in order to electrically connect the ground-contact region 80 and/or the overlap region 40 to the at least one substantially planar conductive conductor layer 36. Two regions 101, 102 with different electrical potentials are formed on the radial extension 113, each of which is directly connected to a corresponding connection pin 63 for supplying power to electric machine 10. The connection pins 63 for supplying power are inserted, for example, directly into through-holes 115 of the printed circuit board 30, preferably, soldered in. Optionally, further pins 116 for signal lines 79 to the microcontroller 84 may be inserted in the radial extension 113, by means of which the processed engine signals may be forwarded to one or more external control units. The connection pins 63 and the further pins 116 extend axially into the connector collar 74 of the connector plug 64. In this embodiment, the bearing plate 56, which is not shown, has a radial web 114 that radially overlaps the radial extension 113 and is connected to the connector plug 64, in particular, latched by means of latching elements 71.

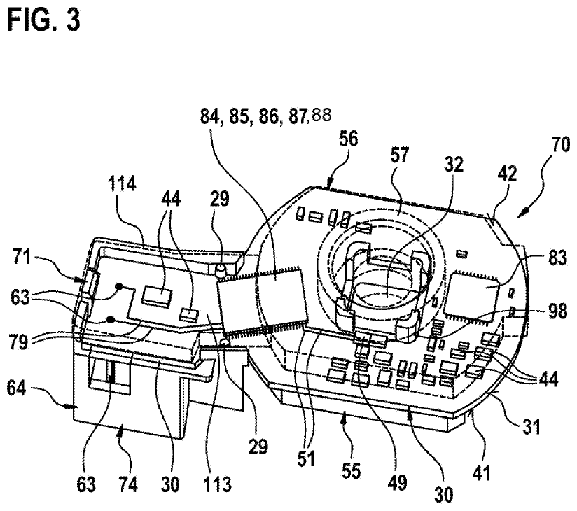

FIG. 3 shows a further version of a sandwich component 70, in which the electronic circuit board 30 is inserted axially between the brush holder plate 55 and the end shield 56. The electrical brushes 20 are again arranged on the brush holder plate 55, which then bear against the commutator 18 of the rotor shaft 16 when inserted into the axially open stator housing 22. The clip or clamping elements 98 extend from the brush holder plate 55 in the axial direction 8 through the central through-hole 32 in the printed circuit board 30, and engage in corresponding receptacles 99 of the bearing plate 56 on the other side of the printed circuit board 30. As a result, the printed circuit board 30 is axially fixed between the brush holder plate 55 and the bearing plate 56, so that the sandwich component 70 may be axially braced as a pre-assembled unit between the stator housing 22 and the gearbox housing 60. The printed circuit board 30 extends, over a substantial part of its circumference 31, in the radial direction 7 beyond the brush holder plate 55 and the bearing plate 56, such that the radially outer region 31 of the printed circuit board 30 may be clamped axially between the flange 28 of the stator housing 22 and a mating flange 61 of the gearbox housing 60. The printed circuit board 30 bears with its underside 41, by way of its overlap region 40, against the metallic flange 28 in order to form a ground contact. The bearing plate 56 is connected to the ground contact region 80 on the upper side 42 of the printed circuit board 30. For this purpose, an electrically conductive adapter element 82 is arranged between the bearing component 58 and the upper side 42 of the printed circuit board 30. The bearing component 58 is fastened in a bearing seat 57 of the bearing plate 56, wherein the bearing plate 56 is in turn fixed in the gearbox housing 60. In FIG. 3, the bearing plate 56, with a radial web 114, overlaps the radial extension 113 of the printed circuit board 30 in the angular region 112 of the connector plug 64. The connector plug 64 is fastened on the one hand to the radial extension 113 and, on the other hand, is connected to the radial web 114 of the bearing plate 56, for example, by means of latching elements 71. In this embodiment, the microcontroller 84 is likewise arranged in the angular region 112 of the connector plug 64; however, in this case it extends partially in the radial direction 7 beyond the stator housing 22 into the radial extension 113 of the printed circuit board 30. As a result, the microcontroller 84 is arranged, particularly advantageously, very close to the pins 63,116 of the connector collar 74. The rotor position sensor 49 is again arranged radially towards the central opening 32 on the printed circuit board 30, and is connected directly to the microcontroller 84 by means of conductor tracks 51. The rotor position signals are processed in the microcontroller 84 through its position processing 85 and anti-pinch function 86. The rotor position signals are also supplied to the current-limiting function 87, which is arranged in the microcontroller 84. Furthermore, an H-bridge circuit 88 is implemented in the microcontroller 84, by means of which energization of the brushes 20 is controlled. In FIG. 3, in particular, a further microprocessor 83 and/or ASIC component is arranged, which, optionally, together with the first microcontroller 84 and, in particular, with further electronic components 44 within the motor housing 22, accommodates the position detection 85 and/or the function of the anti-pinch protection 86, the current-limiting 87, the thermal protection, or the bridge circuit 88 of the motor 10. In this specific embodiment, part of the microcontroller 84 is located radially within the stator housing 22 and another part extends radially beyond the circumferential wall of the stator housing 22 into the radial extension 113 of the printed circuit board 30. The microcontroller 84 is connected to the pins 63, 166 via signal lines 79, for example, to communicate with a central control unit and/or the on-board computer. In particular, further electronic components 44 are arranged around the circumference of the central through-hole 32, which are used, for example, for interference suppression and for further detection of sensor signals.

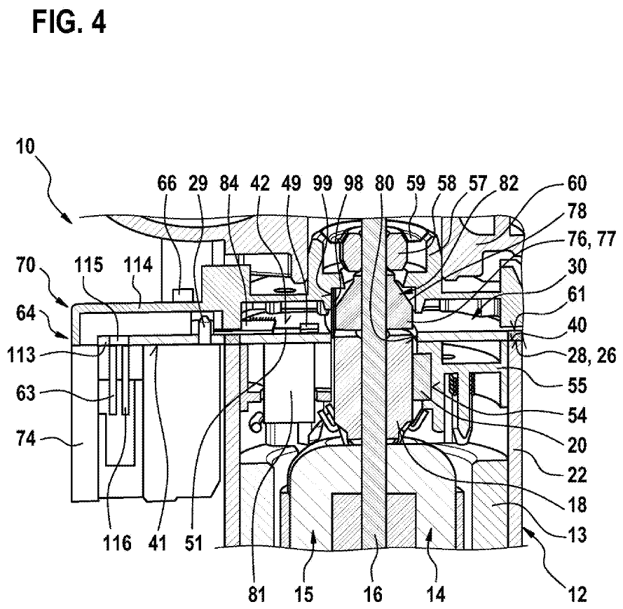

Such a sandwich component 70 as shown in FIG. 3 is installed, for example, in an electric machine 10 of FIG. 4. In FIG. 4, the stator 12 again has permanent magnets 13 that interact with the electrical winding 15 of the rotor 14. The electrical winding 15 is connected to the commutator 18, against which the brushes 20 bear radially. The brushes 20 are arranged in brush cartridges 54 and are pressed radially against the commutator 18 in a spring-loaded manner. In the axial region of the printed circuit board 30, a ring magnet 77 is arranged on the rotor shaft 16 as a signal transmitter 76, which interacts with the rotor position sensor 49 on the printed circuit board 30. In this embodiment, an insertion cone 78 is formed adjacent to the ring magnet 77, which, with the axial placement of the sandwich component 70, causes the brushes 20 to be spread apart in the radial direction 7 so that they may be pushed onto the commutator 18. Axially above the signal transmitter 76, the bearing component 58 is arranged, which in this case is designed as a spherical bearing and is pressed into the bearing seat 57 by means of a spring washer 59. The gearbox housing 60 is placed axially on the stator housing 22 from above in such a way that the printed circuit board 30 is axially braced between the flange 28 of the stator housing 22 and the mating flange 61 of the gearbox housing 60. For example, the gearbox housing 60 is fastened to the flange 28 by means of connecting elements 66, which are designed as screws. The connector plug 64 of the sandwich component 70 is then arranged radially outside the stator housing 22. As shown in FIG. 3, the microcontroller 84 is arranged in the angular region 112 of the connection plug 64, wherein, here, optionally, a part of the microcontroller 84 overlaps in the radial direction 7 with the connection plug 64, wherein the other part of the microcontroller 84 is arranged radially within the stator housing 22. The connector collar 74 is connected to the radial web 114 by means of the latching elements 71, wherein the printed circuit board 30 is also connected to the connector collar 74 by means of fastening elements 29. The microcontroller 84 is connected to the signal sensor 49 by means of conductor tracks 51, such that the position processing 85 and/or the anti-pinch function 86 and/or the current-limiting function 87 are implemented in the microcontroller 84. On the underside 41 of the printed circuit board 30, in particular, an ELCO 81 is arranged as the electronic component 44 for motor control.

It should be noted that with regard to the exemplary embodiments shown in the figures and in the description, a wide range of possible combinations of the individual features are possible. For example, the specific shape of the stator housing 22, the gearbox housing 60, and the connector plug 64 may be adapted to the corresponding application of the electric machine 10. For example, the printed circuit board 30 may also accommodate different electronic components 44 depending on the requirements, wherein different functions may be implemented in the microcontroller 84. The position sensor 49 may also be designed as an inductive or optical sensor. The geometry and configuration of the electronic circuit board 30 may also be varied, and may, for example, be formed with fewer or more than four conductor layers 35, wherein, in particular, at least one planar conductive conductor layer 36 is arranged in the printed circuit board 30. The electrical contacting of the overlap region 40 and/or the ground-contact region 80 may, for example, be implemented by means of a metallic coating of the printed circuit board 30 or by exposing a conductor layer 35 of the printed circuit board 30. The outer circumference of the printed circuit board 30 may also, instead of a flattened circle, have a true circular shape or any outer contour. The invention is particularly suitable for the adjustment of moving parts or for the drive of pumps or aggregates in a motor vehicle, but is not limited to this application.

1. An electric machine (10) having a stator housing (22) which accommodates a stator (12) and a rotor (14), wherein the rotor (14) has a rotor shaft (16) on which a commutator (18) is arranged that is energizable by electrical brushes (20), and the stator housing (22) has an axial opening (24) with a circumferential edge (26) through which the rotor shaft (16) extends from the stator housing (22), wherein a printed circuit board (PCB) (30) is arranged transversely to the rotor shaft (16), and the printed circuit board (30) bears at its peripheral region (31) against the edge (26), and at least partially a microcontroller (84) is arranged on the printed circuit board (30) radially within the edge (26), in which position and rotational direction processing (85) of the rotor (14) is implemented.

2. The electric machine (10) according to claim 1, wherein a rotor position sensor (49) is arranged on the printed circuit board (30), which interacts with a signal transmitter (76) on the rotor shaft (16), and conductor tracks (51) for rotor position signals on the printed circuit board (30) lead from the rotor position sensor (49) directly to the microcontroller (84).

3. The electric machine (10) according to claim 1, wherein an anti-pinch function (86) is arranged in the microcontroller (84), in which the rotor position signals are processable in order to stop and/or reverse the electric machine (10) in response to an unforeseen increase in force when a part being moved is displaced.

4. The electric machine (10) according to claim 1, wherein a current-limiting function (87) for the electrical brushes (20) is implemented in the microcontroller (84) in order to prevent thermal overheating of the electric machine (10) in operation.

5. The electric machine (10) according to claim 1, wherein an H- or B-bridge circuit (88) for controlling the electrical brushes (20) is integrated in the microcontroller (84, 83).

6. The electric machine (10) according to claim 2, wherein the rotor position sensor (49) is configured as a magnetic Hall sensor (49), which is designed as a ring magnet (77).

7. The electric machine (10) according to claim 1, wherein the printed circuit board (30) has, in an insulating substrate, a plurality of spaced-apart conductor layers (35, 36) in an axial direction (8), of which at least one is configured essentially as a conductor layer (36) made of conductive material over its entire area and without circuits, and the conductor layers (35, 36) are electrically connected by a plurality of axial through-plated holes (38).

8. The electric machine (10) according to claim 1, wherein the printed circuit board (30) bears axially in an electrically conductive manner against a flange (28) formed on the edge (26), and wherein the printed circuit board (30) completely covers the opening (24) of the stator housing (22) except for a central through-hole (32) in the printed circuit board (30) for the rotor shaft (16).

9. The electric machine (10) according to claim 8, wherein, on an upper side (42) of the printed circuit board (30) facing away from the flange (28), a separately manufactured bearing plate (56) is arranged, in which a bearing component (58) of the rotor shaft (16) is accommodated, wherein the bearing component (58) is connected to a ground-contact region (80) formed on the upper side (42) of the printed circuit board (30) by an electrically conductive adapter element (82).

10. The electric machine (10) according to claim 8, wherein on an underside (41) facing the flange (28), contact elements (50) for energizing the electrical brushes (20) are arranged, wherein the contact elements (50) are connected to the electrical brushes (20) of a separately manufactured brush holder plate (55).

11. The electric machine (10) according to claim 10, wherein the brush holder plate 55 is connected, by a clip or clamping elements (98), through the central through-hole (32) of the printed circuit board (30), via an adapter element (82), to a bearing plate (56) as a sandwich component (70).

12. The electric machine (10) according to claim 1, wherein the printed circuit board (30), and also the axial opening (24) of the stator housing (22), have circular sections (72), and mutually parallel straight sections (73).

13. The electric machine (10) according to claim 8, wherein the printed circuit board (30) has a radial extension (113) which extends, in a circumferential region (112), radially beyond the flange (28) to a separately manufactured connector collar (74) of a connector plug (64), and connection pins (63) of the connector plug (64) are inserted directly into the radial extension (113) of the printed circuit board (30), wherein the connector collar (74) is connected to a web (114) of a bearing plate (56) that extends radially beyond the flange (28).

14. The electric machine (10) according to claim 13, wherein the microcontroller (84) is arranged in the circumferential region of the connection plug (64) and/or on the radial extension (113) of the printed circuit board (30), wherein the microcontroller (84) and all other electronic components (44) are contacted on an underside (41) and/or an upper side (42) of the printed circuit board (30) by SMD technology (surface-mounted devices).

15. The electric machine (10) according to claim 11, wherein, axially opposite the stator housing (22), a gearbox housing (60) with a mating flange (61) bears against the printed circuit board (30) in order to brace the sandwich component (70) axially between the stator housing (22) and the gearbox housing (60).

16. The electric machine (10) according to claim 1, wherein the conductor tracks (51) for the rotor position signals on the printed circuit board (30) lead from the rotor position sensor (49) directly to the microcontroller (84) without being routed to a connector plug (64) of the electric machine (10).

17. The electric machine (10) according to claim 4, wherein no thermal protection switch is arranged radially inside the stator housing (22).

18. The electric machine (10) according to claim 6, wherein the magnetic Hall sensor (49) is a double Hall sensor, which is arranged radially directly opposite the signal transmitter (76).

19. The electric machine (10) according to claim 11, wherein the contact elements (50) are fastened to the printed circuit board (30) by means of SMD technology.

20. The electric machine (10) according to claim 12, wherein the central through-hole (32) has an approximately square cross-sectional area.
